(19) United States
(12) Patent Application Publication
(10) Pub. No.: US 2008/0168003 A1
(43) Pub. Date: Jul. 10, 2008

(54) SYSTEM AND METHOD FOR SECURITIZING ZERO COUPON BOND AND EQUITY INDEX PORTFOLIOS IN A TARGET DATE EXCHANGE TRADED FUND

(76) Inventor: Thomas Robert WALD, Birmingham, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/757,441

(22) Filed: Jun. 4, 2007

Related U.S. Application Data
(60) Provisional application No. 60/879,748, filed on Jan. 10, 2007.

(51) Int. Cl. G06Q 40/00

(52) U.S. Cl. 705/36 R

(57) ABSTRACT

In a method and system for securitizing Zero Coupon Bonds and Equity Index portfolios, a Target Date Exchange Traded Fund structure is provided that can deliver investors a specific and unchanging portfolio that is precisely designed for an investment horizon between the present and a given Target Date. The ETF holds an index of ZCBs that will protect and guarantee principal at the stated target date. The percentage of the ETF's total value to be invested in this ZCB Index is determined by an exact asset allocation formula calculating the present value of the ETFs current principal. Since ZCBs always trade at a discount to their maturity value, this formula always calculates to less than the ETF's overall value hence allowing the differential to be invested in an Equity Index for long term appreciation of capital. Once the ETF is established and invested under this structure it need not be re-balanced or it may be re-balanced periodically. The ETF may also be re-balanced based on a given level of appreciation or depreciation in the ZCB Index, the Equity Index, or the overall ETF. Any rebalancing is implemented according to this same asset allocation formula. This system and method provides investors seeking a particular time horizon or target date to receive guaranteed protection of principal, absolute transparency regarding how their funds are invested and the potential for meaningful capital appreciation.

### CROSS REFERENCE TO RELATED APPLICATIONS

The application claims priority to U.S. Provisional Application No. 60/879,748 which was filed on Jan. 10, 2007. This application also claims priority to U.S. Utility application Ser. No. 11/294,257 entitled “System and Method for Zero Coupon Bond Based Exchange Traded Fund” which was filed on Dec. 5, 2005.

### BACKGROUND OF THE INVENTION

The present invention pertains to securities, and specifically, but not limited to, exchange traded funds in relation to bonds, such as United States Treasury bonds, and to their underlying bond markets, and in relation to equities and their underlying equity markets.

Many pooled investment vehicles invest substantially all of their assets in various types of securities, derivatives, commodities and other assets. Each such pooled investment vehicle is established using one of several legal structures, such as a “special purpose entity” or an “investment company” registered as such with the Securities and Exchange Commission under the Investment Company Act of 1940, as amended. Shares issued by these pooled investment vehicles may be purchased by individual and institutional investors and may be listed and traded on an exchange.

One particular type of pooled investment vehicle is the exchange traded fund, commonly referred to as an “ETF.” An ETF continuously issues and redeems its shares (hereinafter “ETF shares”) “in-kind” in large lot-sizes (“Creation Units” herein) at a daily net asset value (“NAV” herein) and individually lists its ETF shares on a securities exchange for secondary market trading at intraday prices. The listing exchange publicly disseminates ETF share prices and information about the underlying portfolio assets (“assets” herein) during the trading day.

Several different institutions are involved in establishing an ETF, as well as creating and redeeming large groups of ETF shares in Creation Units and trading smaller groups of ETF shares at prices that closely match the aggregate price of its assets. So, for example, in addition to the listing exchange, there must be a firm or group of firms to organize and establish the ETF. Depending upon the ETF's legal structure, there may also be a manager or a sponsor to monitor the ETF's assets and to perform certain administrative duties. Also, each ETF has a custodian that holds its assets in a special account, receives and pays dividends, and the like. Financial firms called Authorized Participants are also necessary to create and redeem Creation Units. These firms must be capable of borrowing, purchasing, selling and clearing both the ETF's shares and assets “in kind” (e.g. stocks, other securities, forward contacts, gold bullion, and other commodities). In addition, exchange specialists or market makers are necessary to facilitate the trading of individual ETF shares in the secondary market at all times during the trading day. There is also an entity designated to disseminate information about the composition of an ETF's assets to facilitate creation and redemption activity, as well as an index provider if the ETF is based on or intends to track a specified index. Further, an ETF may appoint a firm to serve as distributor of its ETF shares and to perform marketing and advertising duties.

Once the ETF is established, Authorized Participants create Creation Units by purchasing or borrowing the specified kind and requisite amount of assets for deposit with the ETF. The Authorized Participant notifies the ETF of its intent to purchase Creation Units and deposits the assets to be received and held by the custodian. In exchange, the ETF issues its ETF shares in Creation Units to such Authorized Participants. The Authorized Participants may treat the ETF shares as they would any other security, (e.g.) they may hold the Creation Units for their own accounts as principal, fill existing agency orders for individual sales of ETF shares to investors, place the ETF shares into inventory for future sales to investors and lend the ETF shares to short-sellers.

Redemption of Creation Units is simply the reverse of the creation mechanism described in the paragraph above. An Authorized Participant notifies the ETF of its intent to redeem Creation Units, buys the requisite number of ETF shares to constitute one or more whole Creation Units and then tenders such Creation Units for redemption to the ETF. The ETF receives and cancels the tendered ETF shares and notifies the custodian so that the corresponding amount of assets are presented “in kind” to the Authorized Participant. The Authorized Participant, as owner of the assets, may treat them as it would any other like property.

This ETF creation, sale and redemption structure provides each entity involved with the opportunity for gain. The ETF's manager or sponsor generally takes as its fee a small portion of the fund's annual assets, as clearly stated in the prospectus available to all investors. So too, the custodian takes as its fee a small portion of assets, often paid for by the manager or sponsor out of its fees. The investors who lend assets to Authorized Participants to assemble a Creation Unit take a small fee for their services, and those investors who sell assets to the Authorized Participant usually sell them at a profit. The Authorized Participants are primarily driven by profits arising from the difference in price between the portfolio of assets and the price of the ETF shares trading in the secondary market, as well as the gain embedded in the bid-ask spread of the ETF shares. Whenever there is a discrepancy between the NAV of an ETF's assets and the price of its ETF shares trading in the secondary market, an Authorized Participant may seize this arbitrage opportunity and execute the requisite purchase and sale transactions to realize the gain. Historically, this arbitrage mechanism has tended to keep prices of ETF shares very close to the underlying NAV of the ETF's assets.

The ETF structure allows for transparency and liquidity at modest cost. Everyone knows the nature and identity of the assets held by an ETF, fees charged to investors are disclosed, fees earned by Authorized Participants are not paid by ETFs or their shareholders, and individuals as well as institutions can access the secondary market to exit from their investment in ETF shares at any time during the trading day.

U.S. Utility application Ser. No. 11/294,257 describes a system and method for an ETF that uses Zero Coupon Bonds. U.S. Treasury Zero Coupon Bonds originated in the 1980s in conjunction with the Separate Trading of Registered Interest and Principal (STRIP) program which allowed bond dealers to “strip” out interest and principal payments from larger Treasury Bond issues and structure that same risk-free U.S. Government debt in the form of one lump sum payment at the time of maturity. This unique structure has served to differentiate Zero Coupon Bonds from all other traditional cash coupon bonds.

ZCBs accrue all interest throughout the entire life of the bond. No cash interest is paid to bond holders until the maturity date when all accrued interest is paid out with principal. For this reason, ZCBs are the only bonds that always trade at a discount to their par value (also known as “face value”, “maturity value” or “principal value”) regardless of current market interest rates. ZCBs also always carry a market value (also known as “market price”) more deeply discounted to that par value than all other bonds of comparable terms to maturity. For example, a 10 year U.S. Treasury bond issued with a 7% coupon, priced with an 8% yield to maturity (meaning current market conditions warrant an 8% rate) trades at $932.05 per $1,000 of par value. A U.S. Treasury ZCB of the same maturity and yield would be priced at $456.39 per $1,000 par value. Because of this deep discount ZCBs maintain a far greater degree of price volatility than all other Treasury bonds of comparable maturities. Using the example provided above, if the market yield demands were to shift from 8% to 6%, the 7% coupon bond would increase in price to $1,074.39 or in percentage terms 15.3%, while the ZCB would increase to $553.68 or 21.4%. Conversely, if market yields were to rise to 10%, the 7% coupon bond would fall to $813.07, or 11.9% while the ZCB would incur a larger erosion in price to $376.89 or 17.4%.

The predominant measure of a bond's volatility is what is known as its duration and in regard to this measure ZCBs are also unique from all other bonds. Duration is a compilation of a particular bond's weighted average cash flows, which in a conceptual sense serves to identify how much of the bond's combined interest and principal payments occur in the early versus later years of its lifetime. The calculation of what is called MacCauley's Duration can be summarized as follows:

$$Duration = SUM ( \frac{t \times PV \times CF}{Market Price} ) \qquad equation \#1$$

where
“SUM” is a summation;
“t” is a period in which cash flow occurs;
“PV” is present value; and
“CF” is cash flow.

The higher, or what traders and investors often call, the “longer” the duration, the more volatile the bond's price is to changes in interest rates. For traditional coupon bonds, their duration is always a moving calculation, moving up or down continuously with the passing of time and changes in interest rates. Since ZCBs make all of their payments to investors at maturity, these bonds always have the highest (longest) duration, and hence interest rate sensitivity, of any and all other bonds of comparable maturities. Of great importance is the fact that ZCBs have far more transparent durations than all other bonds. Because of the math cited in the MacCauley's Duration formula above, a ZCB's duration is always equal to its maturity (A ten year ZCB has a duration of 10 years, 15 year ZCB has a duration of 15 years, etc.). This transparency in durations for ZCBs is far different than is the case with traditional coupon bonds whose durations can change materially with corresponding movements in market interest rates. Hence, traditional coupon bonds can require constant and complicated re-calculations of their durations every time interest rates change, which in a portfolio of numerous bonds can become quite cumbersome. Conversely, ZCBs are not subject to such lengthy calculations as duration always equals maturity, and in a portfolio, average duration always equals average maturity. Thus, while ZCBs are more volatile to changes in interest rates than are traditional coupon bonds, the precise degree of that volatility is far more transparent to everyday investors.

U.S. Treasury ZCBs are the only long term investment instrument by which the precise future value of all interest and principal payments can be calculated with absolute certainty. Even traditional coupon U.S. Treasury bonds are subject to re-investment risk, the assumed reinvestment rate on periodic interest payments throughout the life of the bond. Since ZCBs have no periodic cash interest payments, there is no re-investment risk, or need for an assumed re-investment rate between purchase and maturity. For this reason, ZCBs make for excellent budgetary investment vehicles for individuals or investors with fixed future payment or liability schedules. For example, suppose an insurance company has calculated they will need to pay out a $1,000,000 liability ten years out in the future. Under such a circumstance, it is likely that company might purchase a ZCB with a $1,000,000 par value at a deep discount (perhaps at about $610,000 assuming a 5% yield-to-maturity). This would make much more sense than to purchase a traditional coupon bond and then take the risk of miscalculating the subsequent reinvestment rate on twenty semi-annual interest payments over the following ten years. In the case of the ZCB, the final value of the bond's accumulated payments at maturity is a known number, with all other bonds it is not. For this reason, ZCBs make excellent investments for retirement planning, college savings, insurance companies, and pension funds.

A possible application for an ETF, such as an ETF that uses ZCBs as outlined in U.S. Utility application Ser. No. 11/294,257, is Target Date investing. Target Date, also referred to as “Target Year” or “Lifestyle” investing has taken on a dramatic increase in recent years as the ongoing change in demographics in the United States has resulted in more individuals and institutions saving for or investing with specific dates or time horizons concurrent with specific known events such as retirement, a college education or some other future event requiring a transfer of wealth or major expenditure. The mutual fund industry has recognized this investor demand and numerous mutual funds are now available allegedly structured to meet these investment objectives. Such funds can often be found in 401(k) and College 529 Plans and generally carry product descriptions such as Target 2025, Target 2030, Target 2035, etc. Such funds are also often found in individually managed IRAs and Uniform Gift or Transfer to Minor (UGMA and UTMA) accounts. In many instances, these funds are referred to as or are officially named “Lifestyle Funds”.

However, such funds take on a fund of funds approach, in which they simply invest in a portfolio of other mutual funds and then engage in complex, esoteric and non-disclosed “asset allocation models” presumably aimed at investing for the particular Target Date in question. Other than simply being told the Fund is being invested for the given Target Date bearing its name, the investor is given little to no information as to how the ever-changing asset allocation models are applied.

Also of note is the fact that no Target Date Funds currently guarantee investor principal in any manner. They simply offer to seek a “more conservative” asset mix as the Target Date nears, but no assurance is given to investors as to what the “conservative” asset mix might be. In essence there is no transparency to the investment process used in Target Date Mutual Funds.

Despite the huge and growing demand for Target Date products, there exists no ETFs dedicated to Target Date investing. Additionally, there exists no ETFs dedicated to Target Date investing with Zero Coupon Bonds. Current ETFs only deal with asset classes in isolation, (large capitalization stocks, small capitalization stocks, technology stocks etc.) as there is currently no ETF products whatsoever designed to help Target Date investors benefit from the low fee, low turnover and highly transparent structures ETFs have to offer. To adequately provide such investors with this type of option, an ETF structure must be able to precisely meet the scheduled budgets and time horizons of the investor base that needs this investment strategy the most.

These and other features of the present invention can be best understood from the following specification and drawings, the following of which is a brief description.

### SUMMARY OF THE INVENTION

A method and system are disclosed for securitizing United States Treasury Stripped Interest and Principal Bonds, Notes and Securities, or as they are otherwise referred to, Zero Coupon Bonds or a Zero Coupon Bond Index (ZCBI) in combination with a common stock portfolio, or as can otherwise be referred to as an Equity Index (EI), in a structure that is invested for a specific time horizon until a designated Target Date. Such a Target Date is officially designated for each and every ETF taking this structure and corresponds within the calendar year to the final maturity date of the longest bond in the ZCB Index. An Exchange Traded Fund (ETF) structure is provided that can effectively secure principal through the use of the ZCB Index while providing for potential appreciation through the use of the Equity Index. The ETF can hold both of these Indexes in a passive manner for the entire life of the portfolio or until the designated Target Date, without any rebalancing, or it may rebalance at the discretion of the ETF sponsor.

A broad index of U.S. Treasury ZCBs is also provided. This Index may be broken into subsets or smaller indexes with maturities corresponding on or slightly before a specific Target Date. By doing so, the investor is guaranteed his or her principal on the designated Target Date. Since ZCBs always trade at a discount to their par value (also referred to as face value, principal or maturity value) the investor can effectively guarantee principal at a future date by investing only a portion of that principal. The remaining amount is then invested in the Equity Index portion of the ETF.

The ETF is structured such that at least three options are provided to the sponsor upon reaching the scheduled target date. 1) The ETF can be fully liquidated with all assets paid out to shareholders. 2) The ETF may remain a listed security under its final portfolio composition for an indefinite period of time allowing shareholders to sell their ETF shares in the open market. 3) The ETF may remain a listed security under its final portfolio composition for a specific time period before converting into a new Target Date ETF. In one example the specific time period is 6 months, however it is understood that other time periods may be used.

These and other features of the present invention can be best understood from the following specification and drawings, the following of which is a brief description.

### BRIEF DESCRIPTION OF THE DRAWINGS

FIG. 1 illustrates a Target Date ETF asset allocation structure at inception and after a Target Date.

FIG. 2 illustrates an asset allocation structure for an example Target Date ETF with a Zero Coupon Bond Index comprising 12 Zero Coupon Bonds.

FIG. 3 illustrates the asset allocation structure of FIG. 2 at a first bond maturity date.

FIG. 4 illustrates the asset allocation structure of FIG. 2 at a second bond maturity date.

FIG. 5 illustrates the asset allocation structure of FIG. 2 at a third bond maturity date.

FIG. 6 illustrates the asset allocation structure of FIG. 2 after the Target Date.

### DETAILED DESCRIPTION OF THE PREFERRED EMBODIMENT

### A. Target Date Investing in an ETF Format

At the present time there are no ETFs dedicated to Target Date Investing despite the massive popularity of both ETFs themselves and the clear consumer demand for Target Date investment products, currently only found in the form of mutual funds or privately managed portfolios. By introducing Target Date ETFs to the market, in the structure described within this application, several important and unique benefits would be available to investors that are not available at the current time. These include:
Protection of Investment Principal—Under the system and method described, investors of Target Date ETFs are able to have up to or potentially more than 100% of their principal guaranteed on the Target Date. This is a feature that is vital to rational investors seeking to save for retirement or a College Education, yet is not available in any Target Date products currently in the marketplace.
Transparency of Portfolio—Under the Target Date process described, investors always know precisely how their funds are invested, down to each individual stock and bond in the Equity Index Portfolio and Zero Coupon Bond Index portfolio. This is a broad and highly conceptual departure from the complicated and non-disclosed asset allocation models used in Target Date mutual funds.
Lower Fee Structure—Target Date ETFs carry management fees at a fraction of the cost of their mutual fund counterparts. This is due to a variety of reasons including the inherently lower cost structure of administering a passively managed ETF portfolio and the fact that Target Date Mutual Funds often charge fees on several funds on top of an overall fee to manage those particular mutual funds.
Bond Maturity Dates—The Target Date ETF described has a meaningful portion of its portfolio invested in U.S. Government risk free bonds corresponding on or slightly before the stated Target Date. This provides for an indisputable alignment of investor objective and investment strategy currently absent in all other Target Date products.

However, it is understood that these benefits are by no means limiting, and that embodiments of the present invention may have other benefits.

### B. Structure of Target Date ETFs

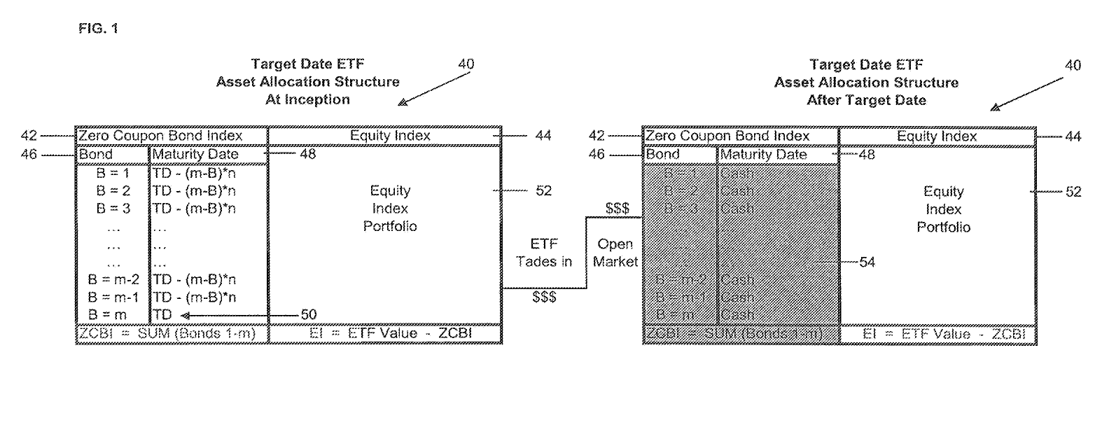

As shown in FIG. 1, a Target Date ETF 40 consists of at least two Indexed Portfolios 42 and 44 that combine to play dramatically different yet complimentary roles in the overall investment strategy of the ETF 40. The U.S. Treasury Separate Trading of Registered Interest and Principal (STRIP) Target Maturity Bond Index (Zero Coupon Bond Index or “ZCBI”) 42 serves to protect and guarantee investor principal while the Equity Index (“EI”) 44 serves to provide for capital appreciation.

The Zero Coupon Bond Target Maturity Index (ZCBI) 42 comprises a plurality of Zero Coupon Bonds (ZCBs) 46, also known as STRIPS, wherein each STRIP matures in a time period on or before a target year which corresponds to a Target Date (“TD”) 50. Each bond 46 in the ZCBI 42 has a bond number “B” and maturity date 48. FIG. 1 uses the variable “m” to indicate the quantity of STRIPS 46 in the Zero Coupon Bond Index 42 and uses the variable “n” to indicate the period of time between each bond maturity date 48. In the United States, this period of time is typically three months, however it is understood that if necessary other periods of time could be used. Most importantly, these The Zero Coupon Bonds 46 provide guaranteed principal protection to investors, something current Target Year mutual funds do not. After the Target Date 50, all of the Zero Coupon Bonds 46 mature and become cash 54. As shown in FIG. 1, “SUM (Bonds 1-m)” refers to a cumulative value of bonds one through “m”.

In one example, the ZCBI Index 42 comprises 12 STRIPS, and each STRIP matures in one of the preceding twelve quarters prior to the latest or longest term bond in the target year. (For example, an ETF 40 with a Target Date 50 of 2020 could consist of 12 bonds, the first of which would mature in February of 2018 and the last in November of 2020).

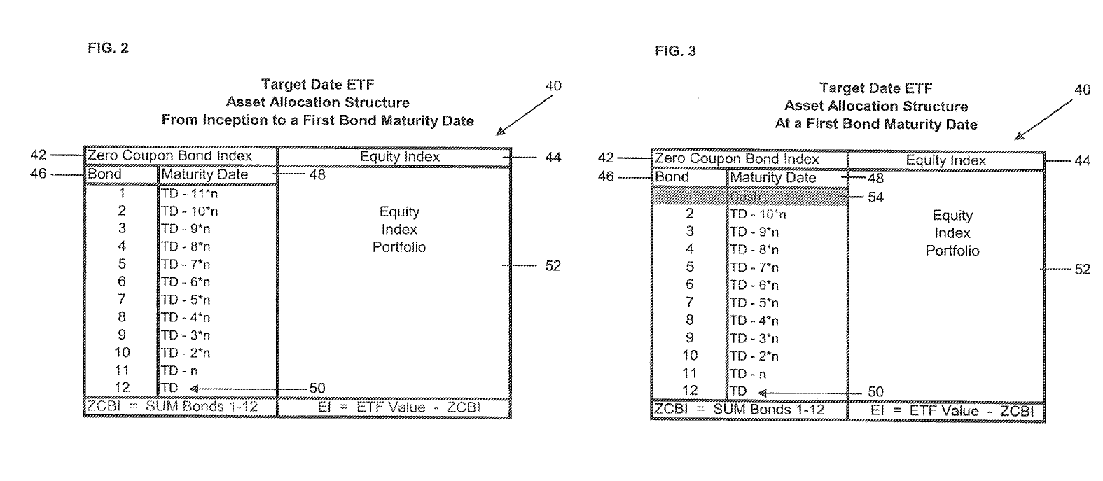

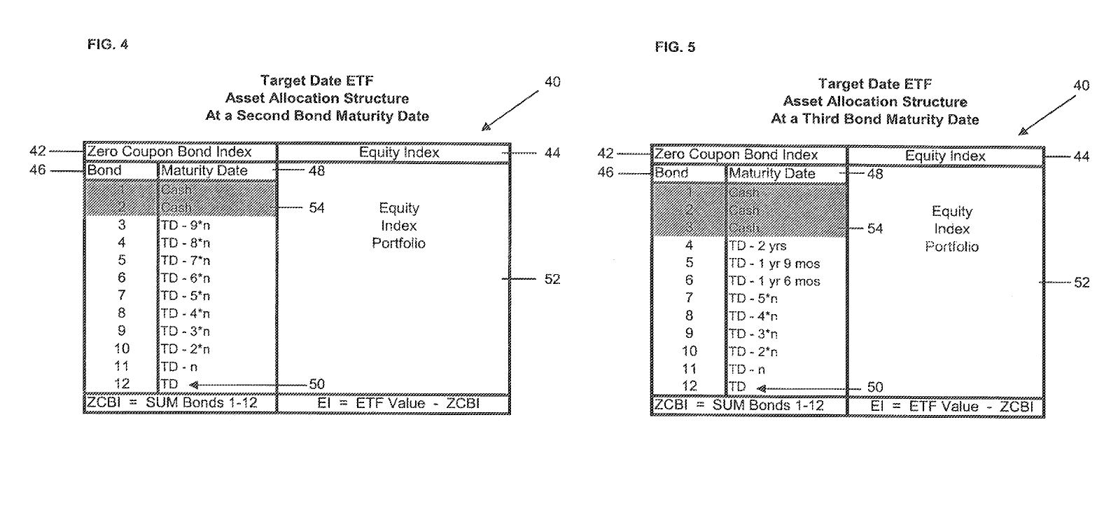

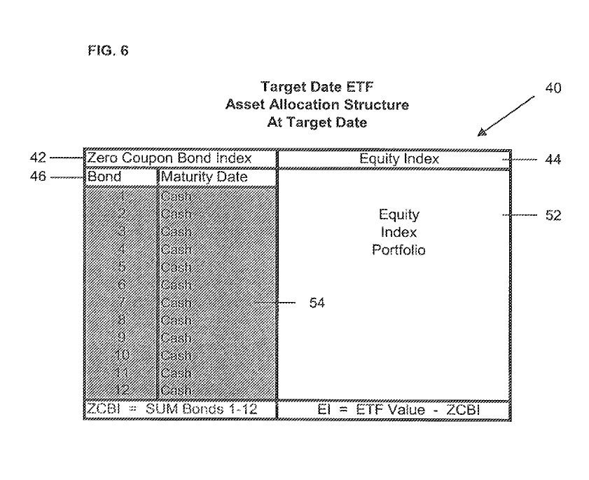

FIGS. 2-6 illustrate an example ETF 40 where “m”=12 so that the ZCBI 42 comprises 12 ZCBs. As shown in FIG. 2, at inception no bonds have matured. As shown in FIG. 3, after a first bond maturity date a first bond matures and becomes cash 54. As shown in FIGS. 3 and 4, after a second and third maturity date, a second and a third bond mature and become cash 54. As shown in FIG. 6, after the target 50 of FIGS. 2-5, all ZCBs 46 in the ZCBI mature and become cash 54.

The composition of each Target Year Index is predicated on the following specific asset allocation formula:

$$\begin{matrix}EI = ETFvalue - ZCBI & equation \#2 \\ ZCBI = {\sum }_{i = 1}^{m} ( \frac{1}{m} \times ETFvalue \times \frac{MP ( {Bond}_{i} )}{FV ( {Bond}_{i} )} ) & equation \#3\end{matrix}$$

where
“EI” is an amount of assets invested in an equity index;
“ETFvalue” is a total of all assets of an ETF;
“ZCBI” is the total value of all Zero Coupon Bonds in a Zero Coupon Bond Index;
“MP” is a market price;
“FV” is a face value; and
“m” is the number of bonds in the ETF.

This formula first determines the amount in dollar and percentage terms of the ZCB Index 42 that is required to fully guarantee existing ETF principal. In an example $12,000,000 Target Date 2030 ETF, the asset allocation formula as shown in equation #2 under current market conditions would dictate that $4,101,000 (34.2%) of the ETF 40 would be necessary to fully guarantee or protect all $12,000,000 in 2030, and would be invested in the ZCBI 42 as dictated by the formula shown in equation #3. Hence, the remaining $7,899,000 (65.8%) would be invested in an equity index 52 to serve as pure incremental return to that guaranteed principal. This asset allocation formula of equation #2 also determines the dollar and percentage compositions of each of the 12 ZCBs 46 within the ZCB Index 42.

The further out the Target Year, the fewer dollars are needed to be placed in the STRIP portion 42 of the ETF 40, allowing for larger portions of the ETF 40 to be comprised of the Equity Index portfolio 52. In one example the STRIP portion would be 47% in 2020, 42% in 2025, 34% in 2030, 26% in 2035, etc.

Unlike the Target Year mutual funds, these Indexes 42 and 44 never need be changed or rebalanced, (although the ETF sponsor may rebalance the Indexes 42 and 44 if it is deemed in the best interests of the ETF shareholders). In a declining stock market, the STRIPS 46 grow to an initial principal allowing for a positive return from origination even during the worst of bear markets. In a rising stock market, the investment performance is still quite competitive with a blended rate somewhere between the initial yield on the STRIPS 46 and the Equity Index 44 total return. (The further out the target year, the closer the total return is to that of the equity index). The low fees of this product line also have a wide appeal to end markets such as 401(k) and other retirement plans.

### C. The Role of ZCBs in Target Date ETFs

ZCBs 46 or in this case a ZCB Index 42 can play a unique and irreplaceable role in Target Date Investing. This is because ZCBs 46 are the only bonds in which an investor knows with absolute certainty how much he or she needs to invest at any given point in time to guarantee a future value. This is not possible with traditional cash coupon bonds because an investor can never know what future interest rates will be earned on the periodic cash interest payments received between purchase and maturity. For this reason the future value of those periodic interest payments at the bond's maturity can not be determined at the time of purchase or at any given point in time prior to maturity. This concept is known as reinvestment risk, in other words an investor of cash coupon bonds must take on the risk of changing interest rates when reinvesting interest payments prior to the bond's maturity. Since ZCBs have no cash interest payments, they have no corresponding reinvestment risk.

This unique concept of a lump sum payment at maturity becomes even more vital with U.S. Treasury STRIPS because that debt is a full fledged obligation of the United States Government and hence judged by the market to be risk-free in nature. Therefore, an investor faces no credit risk, or what is also known as default risk, when investing in U.S. Treasury STRIP Zero Coupon Bonds.

Therefore, without these two elements of risk so prevalent among traditional cash coupon bonds, ZCBs are perfectly suited to play an essential role in Target Date investing.

It is also important to note that regardless of the interest rate environment, ZCBs always trade at a discount to their maturity value. (This is not always the case with cash coupon bonds which may trade at a premium to their maturity or face value if rates decline below the fixed coupon payment). Therefore, with a lifelong discount to its future lump sum payment, ZCBs allow investors to lock in existing principal for a future date in time at a current price less than that principal and then invest that differential in a different asset class, such as common stocks. It is this premise that lays at the foundation of utilizing ZCBs for Target Date Investing.

### D. The ZCB Index

The subject invention contemplates an Index for U.S. Treasury ZCBs, or as they are also known U.S. Treasury STRIPS. The U.S. Treasury ZCB Index consists of all publicly traded U.S. Treasury ZCBs. Currently, this U.S. Treasury ZCB Index consists of approximately 100 ZCBs with maturity dates of February 15, May 15, August 15 and November 15 for the years 2007 through 2036, and is shown below:

TABLE 1
U.S. Treasury Zero Coupon Bond Index
“T-STRIP 100”

| Bond | Coupon | Maturity | Weight |
|---|---|---|---|
| U.S. Treas. Stripped Interest or Principal | 0% | Feb. 15, | 1.00% |
| | | 2007 | |
| U.S. Treas. Stripped Interest or Principal | 0% | Feb. 15, | 1.00% |
| | | 2007 | |
| U.S. Treas. Stripped Interest or Principal | 0% | May 15, | 1.00% |
| | | 2007 | |
| U.S. Treas. Stripped Interest or Principal | 0% | May 15, | 1.00% |
| | | 2007 | |
| U.S. Treas. Stripped Interest or Principal | 0% | Aug. 15, | 1.00% |
| | | 2007 | |
| U.S. Treas. Stripped Interest or Principal | 0% | Nov. 15, | 1.00% |
| | | 2007 | |
| U.S. Treas. Stripped Interest or Principal | 0% | Feb. 15, | 1.00% |
| | | 2008 | |
| U.S. Treas. Stripped Interest or Principal | 0% | May 15, | 1.00% |
| | | 2008 | |
| U.S. Treas. Stripped Interest or Principal | 0% | May 15, | 1.00% |
| | | 2008 | |
| U.S. Treas. Stripped Interest or Principal | 0% | Aug. 15, | 1.00% |
| | | 2008 | |
| U.S. Treas. Stripped Interest or Principal | 0% | Nov. 15, | 1.00% |
| | | 2008 | |
| U.S. Treas. Stripped Interest or Principal | 0% | Nov. 15, | 1.00% |
| | | 2008 | |
| U.S. Treas. Stripped Interest or Principal | 0% | Feb. 15, | 1.00% |
| | | 2009 | |
| U.S. Treas. Stripped Interest or Principal | 0% | May 15, | 1.00% |
| | | 2009 | |
| U.S. Treas. Stripped Interest or Principal | 0% | Aug. 15, | 1.00% |
| | | 2009 | |
| U.S. Treas. Stripped Interest or Principal | 0% | Nov. 15, | 1.00% |
| | | 2009 | |
| U.S. Treas. Stripped Interest or Principal | 0% | Feb. 15, | 1.00% |
| | | 2010 | |
| U.S. Treas. Stripped Interest or Principal | 0% | May 15, | 1.00% |
| | | 2010 | |
| U.S. Treas. Stripped Interest or Principal | 0% | Aug. 15, | 1.00% |
| | | 2010 | |
| U.S. Treas. Stripped Interest or Principal | 0% | Nov. 15, | 1.00% |
| | | 2010 | |
| U.S. Treas. Stripped Interest or Principal | 0% | Feb. 15, | 1.00% |
| | | 2011 | |
| U.S. Treas. Stripped Interest or Principal | 0% | May 15, | 1.00% |
| | | 2011 | |
| U.S. Treas. Stripped Interest or Principal | 0% | Aug. 15, | 1.00% |
| | | 2011 | |
| U.S. Treas. Stripped Interest or Principal | 0% | Nov. 15, | 1.00% |
| | | 2011 | |
| U.S. Treas. Stripped Interest or Principal | 0% | Feb. 15, | 1.00% |
| | | 2012 | |
| U.S. Treas. Stripped Interest or Principal | 0% | May 15, | 1.00% |
| | | 2012 | |
| U.S. Treas. Stripped Interest or Principal | 0% | Aug. 15, | 1.00% |
| | | 2012 | |
| U.S. Treas. Stripped Interest or Principal | 0% | Nov. 15, | 1.00% |
| | | 2012 | |
| U.S. Treas. Stripped Interest or Principal | 0% | Feb. 15, | 1.00% |
| | | 2013 | |
| U.S. Treas. Stripped Interest or Principal | 0% | May 15, | 1.00% |
| | | 2013 | |
| U.S. Treas. Stripped Interest or Principal | 0% | Aug. 15, | 1.00% |
| | | 2013 | |
| U.S. Treas. Stripped Interest or Principal | 0% | Nov. 15, | 1.00% |
| | | 2013 | |
| U.S. Treas. Stripped Interest or Principal | 0% | Feb. 15, | 1.00% |
| | | 2014 | |
| U.S. Treas. Stripped Interest or Principal | 0% | May 15, | 1.00% |
| | | 2014 | |
| U.S. Treas. Stripped Interest or Principal | 0% | Aug. 15, | 1.00% |
| | | 2014 | |
| U.S. Treas. Stripped Interest or Principal | 0% | Nov. 15, | 1.00% |
| | | 2014 | |
| U.S. Treas. Stripped Interest or Principal | 0% | Feb. 15, | 1.00% |
| | | 2015 | |
| U.S. Treas. Stripped Interest or Principal | 0% | May 15, | 1.00% |
| | | 2015 | |
| U.S. Treas. Stripped Interest or Principal | 0% | Aug. 15, | 1.00% |
| | | 2015 | |
| U.S. Treas. Stripped Interest or Principal | 0% | Nov. 15, | 1.00% |
| | | 2015 | |
| U.S. Treas. Stripped Interest or Principal | 0% | Feb. 15, | 1.00% |
| | | 2016 | |
| U.S. Treas. Stripped Interest or Principal | 0% | May 15, | 1.00% |
| | | 2016 | |
| U.S. Treas. Stripped Interest or Principal | 0% | Aug. 15, | 1.00% |
| | | 2016 | |
| U.S. Treas. Stripped Interest or Principal | 0% | Nov. 15, | 1.00% |
| | | 2016 | |
| U.S. Treas. Stripped Interest or Principal | 0% | Feb. 15, | 1.00% |
| | | 2017 | |
| U.S. Treas. Stripped Interest or Principal | 0% | May 15, | 1.00% |
| | | 2017 | |
| U.S. Treas. Stripped Interest or Principal | 0% | Aug. 15, | 1.00% |
| | | 2017 | |
| U.S. Treas. Stripped Interest or Principal | 0% | Nov. 15, | 1.00% |
| | | 2017 | |
| U.S. Treas. Stripped Interest or Principal | 0% | Feb. 15, | 1.00% |
| | | 2018 | |
| U.S. Treas. Stripped Interest or Principal | 0% | May 15, | 1.00% |
| | | 2018 | |
| U.S. Treas. Stripped Interest or Principal | 0% | Aug. 15, | 1.00% |
| | | 2018 | |
| U.S. Treas. Stripped Interest or Principal | 0% | Nov. 15, | 1.00% |
| | | 2018 | |
| U.S. Treas. Stripped Interest or Principal | 0% | Feb. 15, | 1.00% |
| | | 2019 | |
| U.S. Treas. Stripped Interest or Principal | 0% | May 15, | 1.00% |
| | | 2019 | |
| U.S. Treas. Stripped Interest or Principal | 0% | Aug. 15, | 1.00% |
| | | 2019 | |
| U.S. Treas. Stripped Interest or Principal | 0% | Nov. 15, | 1.00% |
| | | 2019 | |
| U.S. Treas. Stripped Interest or Principal | 0% | Feb. 15, | 1.00% |
| | | 2020 | |
| U.S. Treas. Stripped Interest or Principal | 0% | May 15, | 1.00% |
| | | 2020 | |
| U.S. Treas. Stripped Interest or Principal | 0% | Aug. 15, | 1.00% |
| | | 2020 | |
| U.S. Treas. Stripped Interest or Principal | 0% | Nov. 15, | 1.00% |
| | | 2020 | |
| U.S. Treas. Stripped Interest or Principal | 0% | Feb. 15, | 1.00% |
| | | 2021 | |
| U.S. Treas. Stripped Interest or Principal | 0% | May 15, | 1.00% |
| | | 2021 | |
| U.S. Treas. Stripped Interest or Principal | 0% | Aug. 15, | 1.00% |
| | | 2021 | |
| U.S. Treas. Stripped Interest or Principal | 0% | Nov. 15, | 1.00% |
| | | 2021 | |
| U.S. Treas. Stripped Interest or Principal | 0% | Feb. 15, | 1.00% |
| | | 2022 | |
| U.S. Treas. Stripped Interest or Principal | 0% | May 15, | 1.00% |
| | | 2022 | |
| U.S. Treas. Stripped Interest or Principal | 0% | Aug. 15, | 1.00% |
| | | 2022 | |
| U.S. Treas. Stripped Interest or Principal | 0% | Nov. 15, | 1.00% |
| | | 2022 | |
| U.S. Treas. Stripped Interest or Principal | 0% | Feb. 15, | 1.00% |
| | | 2023 | |
| U.S. Treas. Stripped Interest or Principal | 0% | May 15, | 1.00% |
| | | 2023 | |
| U.S. Treas. Stripped Interest or Principal | 0% | Aug. 15, | 1.00% |
| | | 2023 | |
| U.S. Treas. Stripped Interest or Principal | 0% | Nov. 15, | 1.00% |
| | | 2023 | |
| U.S. Treas. Stripped Interest or Principal | 0% | Feb. 15, | 1.00% |
| | | 2024 | |
| U.S. Treas. Stripped Interest or Principal | 0% | May 15, | 1.00% |
| | | 2024 | |
| U.S. Treas. Stripped Interest or Principal | 0% | Aug. 15, | 1.00% |
| | | 2024 | |
| U.S. Treas. Stripped Interest or Principal | 0% | Nov. 15, | 1.00% |
| | | 2024 | |
| U.S. Treas. Stripped Interest or Principal | 0% | Feb. 15, | 1.00% |
| | | 2025 | |
| U.S. Treas. Stripped Interest or Principal | 0% | May 15, | 1.00% |
| | | 2025 | |
| U.S. Treas. Stripped Interest or Principal | 0% | Aug. 15, | 1.00% |
| | | 2025 | |
| U.S. Treas. Stripped Interest or Principal | 0% | Nov. 15, | 1.00% |
| | | 2025 | |
| U.S. Treas. Stripped Interest or Principal | 0% | Feb. 15, | 1.00% |
| | | 2026 | |
| U.S. Treas. Stripped Interest or Principal | 0% | May 15, | 1.00% |
| | | 2026 | |
| U.S. Treas. Stripped Interest or Principal | 0% | Aug. 15, | 1.00% |
| | | 2026 | |
| U.S. Treas. Stripped Interest or Principal | 0% | Nov. 15, | 1.00% |
| | | 2026 | |
| U.S. Treas. Stripped Interest or Principal | 0% | Feb. 15, | 1.00% |
| | | 2027 | |
| U.S. Treas. Stripped Interest or Principal | 0% | May 15, | 1.00% |
| | | 2027 | |
| U.S. Treas. Stripped Interest or Principal | 0% | Aug. 15, | 1.00% |
| | | 2027 | |
| U.S. Treas. Stripped Interest or Principal | 0% | Nov. 15, | 1.00% |
| | | 2027 | |
| U.S. Treas. Stripped Interest or Principal | 0% | Feb. 15, | 1.00% |
| | | 2028 | |
| U.S. Treas. Stripped Interest or Principal | 0% | May 15, | 1.00% |
| | | 2028 | |
| U.S. Treas. Stripped Interest or Principal | 0% | Aug. 15, | 1.00% |
| | | 2028 | |
| U.S. Treas. Stripped Interest or Principal | 0% | Nov. 15, | 1.00% |
| | | 2028 | |
| U.S. Treas. Stripped Interest or Principal | 0% | Feb. 15, | 1.00% |
| | | 2029 | |
| U.S. Treas. Stripped Interest or Principal | 0% | Feb. 15, | 1.00% |
| | | 2031 | |
| U.S. Treas. Stripped Interest or Principal | 0% | Feb. 15, | 1.00% |
| | | 2036 | |

As shown in Table 1, the U.S. Treasury ZCB Index consists of U.S. Treasury Stripped Interest or Principal (Zero Coupon) bonds, notes, or securities of the 100 longest durations, and the years 2007 and 2008 include more than one bond per maturity date. The U.S. Treasury ZCB Index may add new issues as existing bonds reach maturity, and total index holdings may fluctuate slightly above or below 100 bonds.

### E. The Life Cycle of a Target Date ETF and the Asset Allocation Formula

The initial asset allocation between the Equity Index Portfolio and the Zero Coupon Bond Index Portfolio is determined at the point of inception according to the asset allocation formula of equation #2.

In Summary, the Zero Coupon Bond Index (ZCBI) 42 consists entirely of risk-free U.S. Treasury STRIPS 46 invested at the ETF's inception to lock in existing principal for the life of the ETF 40. This is accomplished by dividing that principal, or initial capital investment, into a plurality of equal portions, and assigning each portion of that principal protection to a ZCB 46 in the ZCB Index 42. In one example the principal is divided into 12 equal portions, however it is understood that other quantities of equal portions may be used. The remaining amount of that initial principal is then invested in the Equity Index 44.

Table 2 illustrates an example ETF with a Target Date of 2030, having assets of $12,000,000 at inception. The ETF 40 of Table 2 has 12 zero coupon bonds in its ZCBI, and each ZCB has a maturity date and a market price. The bond maturity dates correspond to a given Target Date in the year 2030 and the 11 maturity dates preceding that given Target Date in 2030. For this example ETF, the asset allocation formula looks as follows:

TABLE 2
Target Date 2030 ETF Example

ETFvalue = 12,000,000
EI = 12,000,000 − ZCBI
m = 12
$ZCBI = {\sum }_{i = 1}^{12} ( \frac{1}{12} \times 12 \text{,} 000 \text{,} 000 \times \frac{MV ( {Bond}_{i} )}{FV ( {Bond}_{i} )} )$

Where:

| | Maturity | Market Price | Face Value | 1/12 ETF | Total |
|---|---|---|---|---|---|
| Bond 1 | May 15, 2027 | 350.0 | 1000 | 1,000,000 | 350,000 |
| Bond 2 | Aug. 15, 2027 | 348.5 | 1000 | 1,000,000 | 348,500 |
| Bond 3 | Nov. 15, 2027 | 347.0 | 1000 | 1,000,000 | 347,000 |
| Bond 4 | Feb. 15, 2028 | 345.5 | 1000 | 1,000,000 | 345,500 |
| Bond 5 | May 15, 2028 | 344.0 | 1000 | 1,000,000 | 344,000 |
| Bond 6 | Aug. 15, 2028 | 342.5 | 1000 | 1,000,000 | 342,500 |
| Bond 7 | Nov. 15, 2028 | 341.0 | 1000 | 1,000,000 | 341,000 |
| Bond 8 | Feb. 15, 2029 | 339.5 | 1000 | 1,000,000 | 339,500 |
| Bond 9 | May 15, 2029 | 338.0 | 1000 | 1,000,000 | 338,000 |
| Bond 10 | Aug. 15, 2029 | 336.5 | 1000 | 1,000,000 | 336,500 |
| Bond 11 | Nov. 15, 2029 | 335.0 | 1000 | 1,000,000 | 335,000 |
| Bond 12 | Feb. 15, 2030 | 333.5 | 1000 | 1,000,000 | 333,500 |
| ZCBI Total | | | | | 4,101,000 |

EI = 12,000,000 − 4,101,000 = 7,899,000

| | | | |
|---|---|---|---|
| EI | = | 7,899,000 | 65.8% |
| ZCBI | = | 4,101,000 | 34.2% |
| | | 12,000,000 | 100% |

Once implemented, this asset allocation composition need not necessarily be changed, and as new capital comes in to the ETF 40 it can be invested according to the ongoing asset allocation portfolio composition. The ZCB Index 42 guarantees 100% of the principal (before fees) to the initial investors. If the Equity Index 44 rises in value, the ZCB Index 42 guarantees something less than 100% of the principal to new investors, and if the Equity Index 44 falls in value the ZCB Index 42 guarantees more than 100% of principal to those new investors. This creates an interesting safeguard mechanism in that the ZCB Index 42 helps the ETF 40 to become more conservative throughout a prolonged bear equity market.

This asset allocation formula as shown in equation #2 can also be used for rebalancing the asset allocation between the Equity Index 44 and ZCB Index 42 on a scheduled basis, or at any point during the ETF's lifecycle, should the ETF sponsor deem it to be in the best interests of the ETF shareholders. The purpose of potentially rebalancing might be to ensure 100% principal protection of the existing asset base to all current shareholders which may prove a prudent gesture periodically in the event of a prolonged bull market. In other words, should the Equity Index 44 appreciate considerably, this formula can be used at any point in time to lock in that appreciation in the form of a higher weighting in the ZCB Index 42, in essence shifting that Equity Index 44 appreciation into guaranteed principal, while still keeping a meaningful portion of the overall ETF value in the Equity Index 44.

The asset allocation formula may also be used by the ETF sponsor in the event the Equity Index Portfolio 52 experiences a decline in value. Under such a circumstance the ZCB Index 42 would then guarantee more than 100% of the ETF's total principal. Therefore it might be prudent to recalculate the asset allocation of the two indexes 42 and 44 in order to once again guarantee 100% of the ETF principal, in essence adding to the Equity Index portfolio while still providing complete protection of principal to investors.

This use of the formula in a rebalancing fashion may be implemented at the discretion of the ETF sponsor based upon a calendar year criteria (annually, bi-annually, etc.) or based on a given level of market appreciation or depreciation in the Equity Index 44 or overall ETF 40 (increase or decrease of 10%, 20%, 30%, etc.).

FIG. 6 illustrates an asset allocation structure when an ETF 40 reaches it's actual Target Date 50. At this time, the sponsor has at least three options. The first is to simply liquidate all the holdings (at that point consisting of cash 54 from all the ZCBs having reached maturity plus the value of the Equity Index Portfolio 52) and pay out all shareholders in full. A second alternative is to simply keep its final asset allocation in tact and let the ETF 40 continue to trade in the market indefinitely. The third would be to let the ETF 40 trade in the open market under its final asset allocation for a specific period of time, before converting into a new Target Date ETF under the same formula. In one example, the period of time would be approximately six months, although it is understood that other periods of time could be used. In all three scenarios, ETF shareholders would be able to cash out their respective value at or near the given Target Date 50.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. An investment system, comprising:
an exchange traded fund having a target date, wherein a first portion of assets of the exchange traded fund are invested in a zero coupon bond index and a second portion of assets of the exchange traded fund are invested in an equity index, and wherein an asset allocation formula is used to determine how much of the assets are invested in the zero coupon bond index and in the equity index.

2. The system of claim 1, wherein the zero coupon bond index comprises a plurality of zero coupon bonds.

3. The system of claim 2, wherein each zero coupon bond has a maturity date, and wherein the latest maturity date corresponds to the target date.

4. The system of claim 1, wherein the equity index comprises a stock portfolio.

5. The system of claim 1, wherein a sufficient amount of assets are invested in the zero coupon bond index to guarantee an investor's principal.

6. The system of claim 1, wherein assets are invested in the equity index to provide appreciation.

7. The system of claim 1, wherein the asset allocation formula is used to rebalance the allocation of assets between the equity index and the zero coupon bond index.

8. The system of claim 1, wherein the allocation of assets is rebalanced periodically.

9. The system of claim 1, wherein upon reaching the target date, the exchange traded fund is liquidated to create proceeds to be distributed to the investors.

10. The system of claim 1, wherein upon reaching the target date, the exchange traded fund maintains a final composition of the equity index plus cash for a period of time, allowing the investors to sell their exchange traded fund shares.

11. The system of claim 1, wherein upon reaching the target date, the exchange traded fund maintains its equity index plus cash for a period of time, and after the period of time the exchange traded fund is converted into a new exchange traded fund with a new target date.

12. The system of claim 1, wherein the asset allocation formula divides the assets into a number of equal parts and assigns each of the parts to a zero coupon bond in the zero coupon bond index, wherein a sufficient portion of each of the parts is used to purchase zero coupon bonds to secure the value of the assets, and wherein any remaining amount of the assets are invested in the equity index.

13. A method of target date investing, comprising:
investing a first portion of assets in a zero coupon bond index to secure principal of the assets, wherein the zero coupon bond index comprises a plurality of zero coupon bonds, and wherein a maturity date of a zero coupon bond in the zero coupon bond index corresponds to a target date;
investing a second portion of the assets in an equity index to provide appreciation of the assets; and
using an asset allocation formula to determine how much of the assets to allocate to the first portion and to the second portion.

14. The method of claim 13, wherein the equity index comprises a stock portfolio.

15. The method of claim 13, wherein the asset allocation formula divides the assets into a number of equal parts and assigns each of the parts to different zero coupon bonds of varying maturity dates within a zero coupon bond index to secure the value of the assets, and wherein the remaining amount of the assets is invested in the equity index.
